(19) United States
(12) Patent Application Publication
(10) Pub. No.: US 2005/0220947 A1
(43) Pub. Date: Oct. 6, 2005

(54) Container for packaging perishable food items

(75) Inventor: Joseph E. Owensby, Spartanburg, SC (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Cryovac, Inc.

(21) Appl. No.: 10/817,303

(22) Filed: Apr. 2, 2004

(51) Int. Cl. A23C 1/00

(52) U.S. Cl. 426/316

(57) ABSTRACT

There is provided a container for packaging a perishable food item, such as meat, particularly fresh red meat. The container has a tubular body portion that is closed at one end and has a tubular body portion. The other end of the tubular body portion has an open mouth and has a cross-section preferably substantially equal to that of the body portion. The cross-section of the tubular body portion may have a variety of shapes. In a preferred embodiment, the tubular body portion has a flat bottom. The flat bottom may have an undulating profile at each side forming trough-like areas to accumulate the juices from the meat. Another embodiment has a more or less cylindrical shaped tubular body portion. While a third embodiment is a container having a tubular body portion formed in a more or less rectangular cross-section. The open end serves as a mouth by which the container is filled with a food item, such as by using an automatic chute and plunger. The open mouth is closed by sealing a film of heat sealable material over the opening and/or by an endcap.

### BACKGROUND OF THE INVENTION

1. Field of the Invention

The present invention relates to containers for packaging perishable food items. More particularly, the present invention relates to a container for packaging case ready meats that maximizes product visibility, maximizes retail display case usage, can be easily opened or re-sealed, and provides for optimum usage of packaging material.

2. Description of Related Art

In decades past, meat in grocery store display cases was typically store cut and ground on site. In contrast, case-ready meats are prepackaged in plants and delivered to supermarkets, which affords retailers several advantages. One of the main advantages of using case-ready meats is that it eliminates further processing at the store. This allows retailers to reduce labor costs and increase profitability. Retailers are able to keep meat counters stocked late at night, on holidays, and through weekends. Additionally, case-ready meats allow retailers to order specific cuts of meat to suit customer demand.

Presently, case-ready packages involve the use of a tray for packaging a product. In a tray package, the product is loaded into a thermoformed tray, and the tray is sealed with a flexible clear wrapper. Current meat trays typically waste a great deal of space in retail display cases. For example, on average, a typical meat tray used for high oxygen ground beef has approximately 60 square inches of surface area. Of these 60 square inches, the sealing flange takes up approximately 24 square inches. This means that approximately 40% of the typical grocery store display case is not used for its intended purpose of storing and displaying meat. Typical containers for such applications always have the large open end of the container as the portion where the product is loaded. Typical maximum aspect ratio of thermoformed containers is somewhere around 3.5 inches deep for a minimum opening dimension of 5 inches or 3.5/5=0.7.

Food containers made from thermoplastic materials are, of course, well known for the packaging of potato chips, cookies and the like. For example, U.S. Patent Application Publication No. 2003/0080135 to Bezek discloses a thermoplastic container for packaging a single stack of fragile food products. The container has a thermoplastic circular, generally tubular body having a closed end and an open end and corrugated side walls for dissipating stress that counteract the forces that cause container deformation, implosion, and loss of seal integrity. Such containers are designed to be stored vertically on the closed end. The use of such containers is designed for fragile foods; thus the storage of meat is not disclosed.

U.S. Pat. No. 6,422,414 to Nakamura, et al. discloses a wide-mouth container made by blow molding or injection molding having a body portion and a bottom portion closing one end of the body portion and a wide mouth formed at the other end of the body portion. The wide mouth portion contains a flange extending from a peripheral portion of the wide mouth to accommodate a top suitable for sealing the contents under pressure. The container is used to store tennis balls.

U.S. Pat. No. 6,555,033 to Cargile, et al. discloses a method and apparatus for making a thermoplastic container using a combination of blow molding and compression molding techniques that can hold food products, non-food products, or beverages. The container is cylindrical in shape and has a lid that can be joined to the body of the container by a closure and lip having cooperating threads, a closure and lip providing a friction fit, or a closure and lip which snap fit. Alternatively, a separate piece of film or shrink-wrap can be utilized to maintain the closure on the container lip until initial removal of the closure by a consumer to maintain a sterile environment and provide an indication of tampering. This container is intended to be stored vertically on its circular bottom.

U.S. Pat. Nos. 5,342,663 and 5,507,998 to Yokobayashi disclose a method of injection molding a plastic container in the shape of a can. The can is designed to contain drinks and other fluids, such as oil. The use of the container to store food, and specifically meat, is not disclosed. Likewise, neither the manipulation of the atmosphere to achieve desired storage conditions nor the transparency of the container is disclosed.

Accordingly, there is a need for a container that can increase the amount of case-ready meat that can be stored in a display case while at the same time maximizing product visibility and quality. It is important that the container is stackable and at least partially transparent, and it is also important that the atmosphere of the container can be manipulated prior to sealing in order to ensure the freshness and attractiveness of the meat. Prior containers address some of these concerns, but not all of them at the same time.

### BRIEF SUMMARY OF THE INVENTION

It is an object of the present invention to provide a package for perishable food items such as meat.

Another object of the present invention is to provide a case-ready meat package that takes up less display space in the supermarket than present containers.

A further object of the present invention is to provide a method for filling the containers of the present invention with meat.

It has been found that the foregoing objects may be accomplished in accordance with this invention by providing a container and method for packaging perishable food items—particularly case-ready meats—incorporating the use of a container made from blow-molded or profile-extruded thermoplastic barrier material and sealing the open end. The uniqueness of the package is the type of container used, how the container is made and also how the container is loaded and displayed. In general, the container has a high aspect ratio and the open area of the container is smaller than the non-open portion of the container.

In a first embodiment of the invention there is provided a container for packaging a perishable food item such as meat. The container has a tubular body portion that is closed at one end. The other end of the tubular body portion has an open mouth for inserting the food product and has a cross-section preferably substantially equal to that of the body portion. The cross-section of the tubular body portion may take a variety of shapes but one preferred embodiment has a flat bottom. The flat bottom may have an undulating profile at each side forming trough-like areas to accumulate the juices from the meat. In another embodiment, the cross-section of the tubular portion has a bottom, sides that extend slightly outwardly and an arcuate top. Yet another embodiment has a more or less cylindrical shaped tubular body portion. A third embodiment is a container having a tubular body portion formed in a more or less rectangular cross-section. The tubular body portion is closed at one end. The other end of the tubular body portion has an open mouth. The container is filled through the open mouth with a food item. One example of such a filling process is by using a chute and plunger. The open mouth is closed by sealing a film of material over the opening and/or by an endcap that can be attached by screw threads or formed around the body of the container. When packaging meat, once the meat is inserted in the container, the atmosphere in the container may be manipulated to achieve desired storage and display conditions.

These containers have no flanges to waste display area. The invention is designed to minimize the surface area of the container needed to display a certain amount of meat in a display case. Accordingly, the container lacks large flanges that waste display case area. In one embodiment, the body portion of the container has a relatively small flange portion that projects from the periphery of the mouth opening so that a lid can be attached.

Other objects, features and advantages of the invention will become evident from the following description of the drawings and detailed description of the invention.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a perspective view of an embodiment of the present invention showing a container for packaging perishable food items such as meat having a flat side;

FIG. 2 is a cross-sectional end view of a meat package according to the present invention taken along line 2-2 of FIG. 1;

FIG. 2A is a cross-sectional end view of another embodiment of meat package according to the present invention;

FIG. 3 is a perspective view of a number of the containers of FIG. 1 illustrating the space savings and stackability of the containers arranged for display;

FIG. 4 is a perspective view of another embodiment of this invention showing a row of cylindrical meat packages arranged in a display case;

FIG. 5 is a cross-sectional side view of a cylindrical container of the present invention taken along line 5-5 of FIG. 4;

FIG. 6 is a close-up, partial, cross-sectional view of the portion of a cylindrical meat package showing the placement of the sealing film on the open mouth of the container;

FIG. 7 is a perspective view of another embodiment of the present invention showing a number of containers each having a generally rectangular shape positioned for display in a retail display case;

FIG. 8. illustrates a meat product positioned to be inserted into a container of the present invention;

FIG. 9. illustrates inserting a meat product into a container of the present invention;

FIG. 10 illustrates a method of sealing the open end of the meat package of the present invention; and

FIG. 11 illustrates an apparatus for modifying the atmosphere in a meat package using a container of the present invention.

### DETAILED DESCRIPTION OF THE INVENTION

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

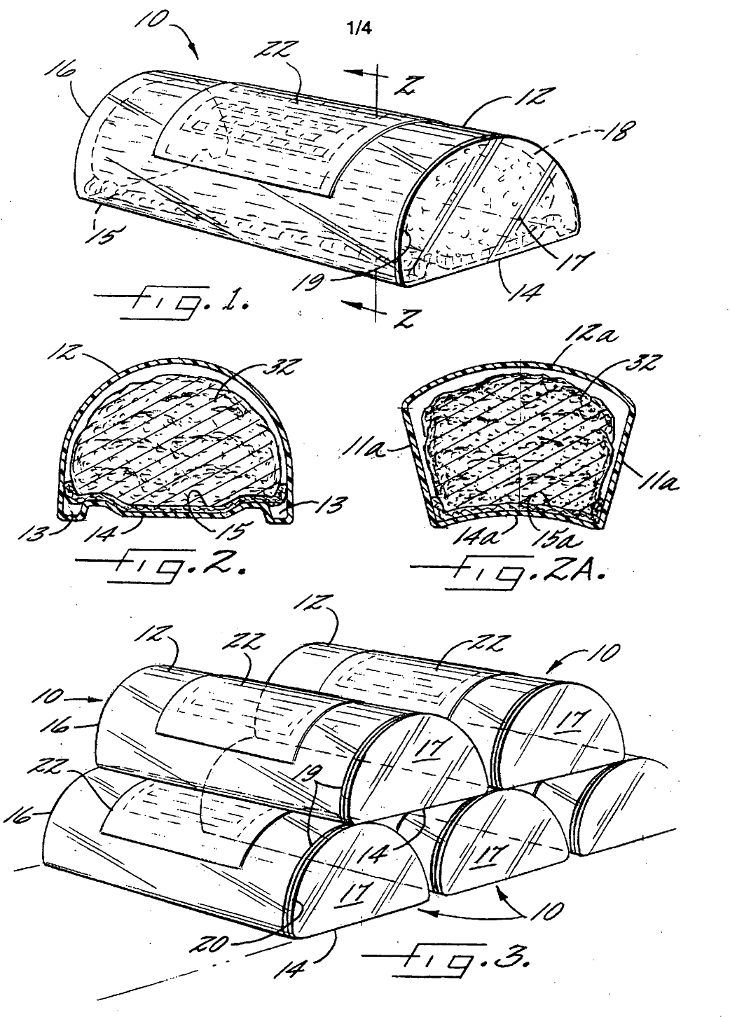

Referring now to the drawings there is illustrated in FIG. 1 a first embodiment of the present invention showing a container 10 for packaging a perishable food item such as meat. As shown in FIG. 1, the container 10 has a tubular body portion 12 and a flat bottom 14. The tubular body portion 12 is closed at one end 16. The other end of the tubular body portion 12 has an open mouth 18 for inserting the food product. As will be discussed in greater detail, the open mouth 18 preferably has a cross-section substantially equal to that of the body portion. In a preferred embodiment, that shown in FIG. 2, the flat bottom 14 has an undulating profile at each side of the flat bottom 14 forming trough-like areas 13 to accumulate the juices from the meat. As used herein the term “tubular” is intended to mean shapes that are not necessarily limited to cylindrical cross-sections, such as a flat bottom, a rectangular cross-section and other appropriate shapes. In a related embodiment, that shown in FIG. 2A, the cross-section of tubular portion 12a has a somewhat flat bottom 14a that is slightly concave to provide for better stacking. The container 12a has generally outwardly sloping sides 11a and an arcuate top.

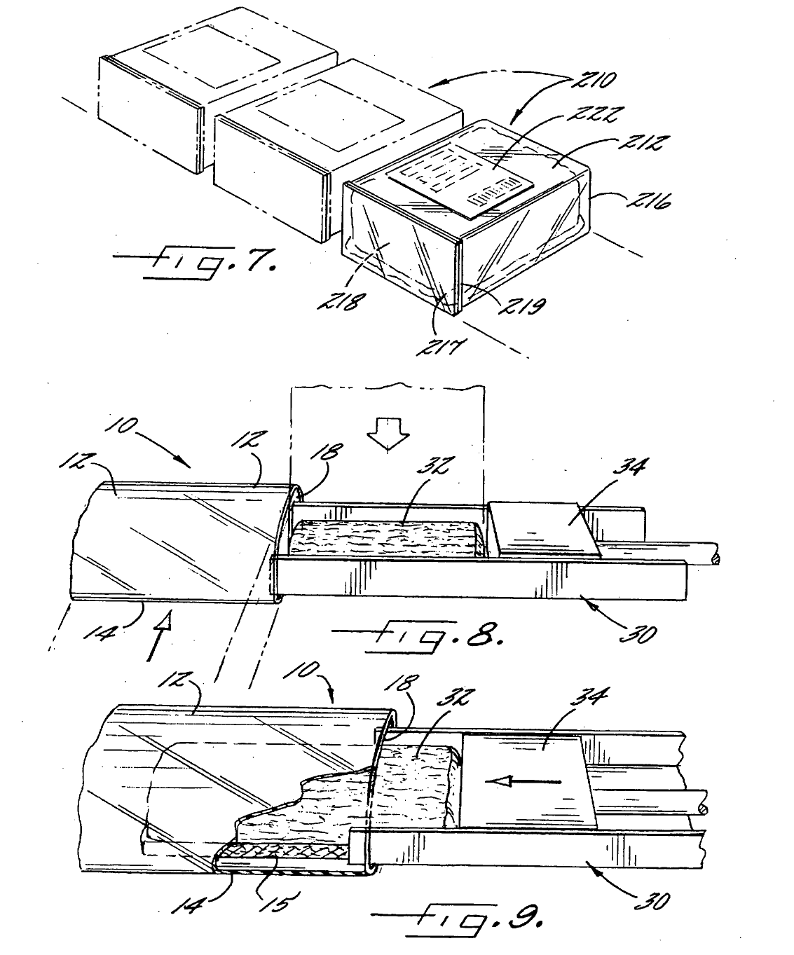

The open mouth 18 forms a rim 19 defining a peripheral sealing surface to which flexible film 17 may be sealed in a conventional manner, such as by heat sealing to maintain a desired atmosphere within the container. Alternatively, the open mouth 18 may also have a lip 124, such as that shown in FIG. 6 formed around the rim 19 to better accommodate the sealing film. The heat sealable film may be any of the conventionally used films for meat packaging, such as a transparent polyester film coated with polyvinylidene chloride copolymer or coated with an amorphous polyester seal layer. Often the user may not use all of the food item and wish to save the remainder. In such cases, a removable and replaceable endcap 20 is provided to fit around the open mouth 18 of the tubular body portion 12. After the container is filled with meat and sealed, an endcap 20 may be tightened against the rim 19, e.g. via friction-fit, tack-weld, or screw threads, so that the container may be reused. In one embodiment of the invention the perishable food item may simply be protected by using an endcap without sealing. Such an endcap 20 provides easy access to the food item.

As noted, the containers of this invention may be used to package meat. In doing so the meat will produce juices (exudate) that will flow to the bottom of the container and look unsightly and will reabsorb into the meat when the package is carried from the display case to the purchaser's home. For those high oxygen packages containing meats, it is desirable to place an absorbent pad 15 to cover the bottom 14 of the container such as the one is shown in FIG. 2 or absorbent pad 15a as shown in FIG. 2a to absorb the juices and to keep this area of the meat from being viewed. An example of a suitable pad is a Dri-Lok® absorbent pad available from Sealed Air Corp.

The container 10 is preferably formed from a transparent, or at least substantially transparent, plastic material, e.g. a molded thermoplastic polymer such as a polyethylene terephthalate (PET) or other polyester, a polypropylene (PP), a nucleated PP, or polyvinyl chloride (PVC). The package may be made from recycled PET, either in full thickness, or as a portion of the thickness separated from the product by a layer of virgin PET. The container may also be made from materials that are microwavable, or suitable for all types of re-heating including cooking in the package, e.g., a nylon material.

In addition, the container may be a coextruded structure containing a barrier layer comprising, e.g. ethylene vinyl alcohol copolymer (EVOH), polyamide (PA), polyvinylidene chloride copolymer (PVDC), or any other polymer that is capable of providing a desired barrier to the transmission of gas therethrough. As used herein, the term “barrier layer” refers to a film layer that admits less than 1000 cc of gas, such as oxygen, per square meter of film per 24 hour period at 1 atmosphere and at a temperature of 73° F. (at 0% relative humidity). More preferably, a barrier layer admits less than about 500, such as less than 300, less than 100, less than 50, or less than 25 cc of gas per square meter per 24 hour period at 1 atmosphere and at a temperature of 73° F. (at 0% relative humidity), such as less than 20, less than 15, less than 10, less than 5, or less than 1 cc of gas per square meter per 24 hour period at 1 atmosphere and at a temperature of 73° F. (at 0% relative humidity).

The thickness of the container walls may vary but generally the tubular body portion 12 is about 10 mils to about 20 mils thick, preferably about 15 mils. The container may be made using a conventional blow molded or a profile-extruded process. The bottom 14 may be made from a non-transparent plastic to keep the bottom of the food item from being seen. All or a portion of the top and sides may be substantially transparent. The transparency may be measured using ASTM D 1003-97, “Standard Test Method for Haze and Luminous Transmittance of Transparent Plastics”. Using this procedure, a value of 50% haze would be a high level, with the product being barely visible. A preferred level of transparency is less than 25%, e.g., 20% or less, 15% or less, 10% or less, or 5% or less. Such low haze levels provide excellent product visibility.

When the container is a meat package, it is preferable that the interior of the tubular portion 12 has an anti-fog coating in the inside to display a meat product that contains moisture. The anti-fog agent may be added by coating the inside of the container after it is made or can be added as a portion of the inside layer of the container. Such coating may be a hydrophilic anti-fogging finish, for example Cirrasol® PP842 from Uneqma, which is a blend of non-ionic lubricants and wetting agents.

The container 10 may have indicia 22 printed on or adhered to the walls of the tubular body portion 12 or to the endcap 20. The indicia 22 may include the typical labeling information such as product identification, weight, animal history, product tracking, and the like. The container may have labels on or adhered to the walls of the tubular portion or to the end cap. The indicia may also include a printed shrink fitted label to the outside of the tubular portion.

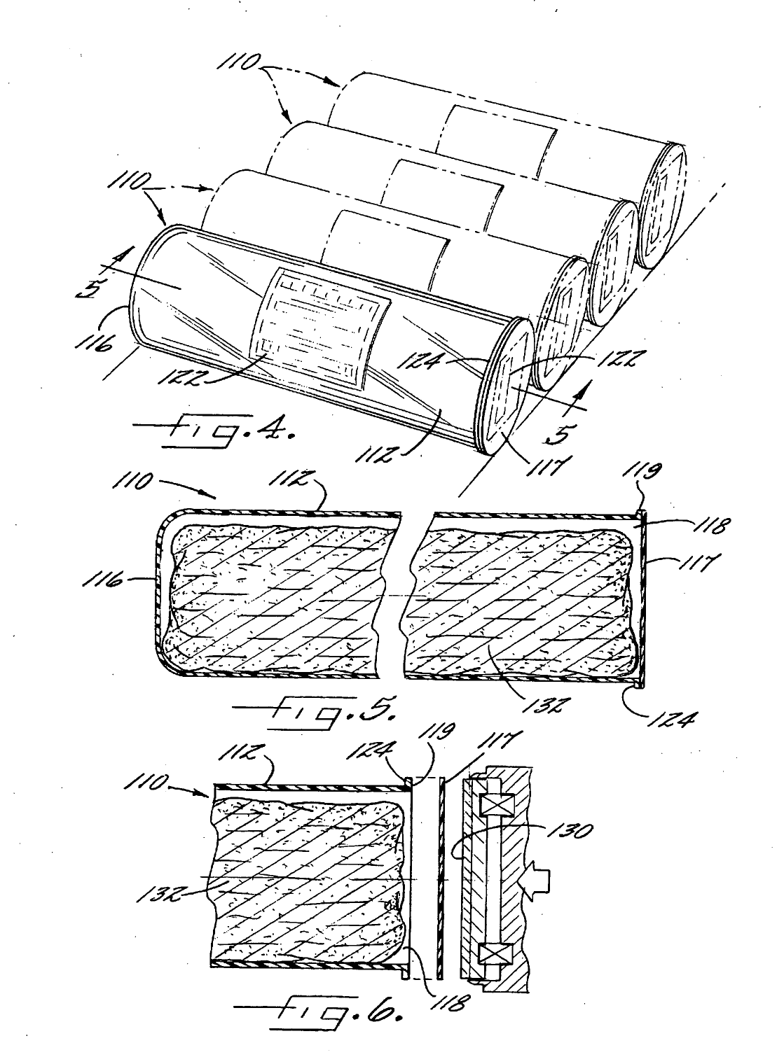

One of the advantages of the container of this invention is that it takes up less space in the display case than present meat packages. Another advantage is that, as shown in FIG. 3, the package has a profile to allow multiple packages to be stacked on top of other packages, i.e., this means the bottom of one package intermeshes with the top profile of the lower package to allow them to be more efficiently stacked in the display case and to allow for better viewing of the product in the package.

Since the containers of the present invention are not made by a conventional thermoforming process used to make trays, the containers are not limited to the typically low aspect ratios achievable by conventional thermoforming processes. By “aspect ratio,” it is meant the depth (or length) of the container, divided by the diameter or smallest dimension, e.g., width, of the opening through which the meat is inserted. Thus, for a container having a rectangular-shaped opening, the short dimension (width) of the rectangle would be used in the aspect ratio calculation instead of the long dimension of the rectangle. For a container having a circular opening, the diameter of the circular opening would be used. For a container having an oval-shaped opening, the minor, rather than the major, axis would be used. The typical maximum aspect ratio of thermoformed containers is approximately 0.7 (e.g., a container depth of 3.5 inches divided by a minimum opening width of 5 inches). The containers of the present invention typically have a higher aspect ratio. For example, for a container having a minimum opening width of 2.5 inches, a depth of 5 inches or more can be achieved, resulting in an aspect ratio of at least 2 (5/2.5). In general, containers in accordance with the present invention will have an aspect ratio of at least 0.7, such as at least 1, 1.5, or 2. Because the containers of this invention have no flanges to waste display area, and have higher aspect ratios than can be obtained with thermoformed containers, the enclosed product is displayed more efficiently and attractively. For instance, the containers of this invention are displayed with the initially open end of the container on the side, as opposed to a trayed product that is displayed with the initial open portion facing upward. The containers thus present the packaged product in a visually enhanced manner relative to a conventional tray display, e.g., because the product can be viewed from the top and sides as opposed to only the top as with tray displays.

Referring now to another embodiment, that embodiment illustrated by FIGS. 4-6, there is shown in FIG. 5 a cylindrical container 110. The container 110 has a tubular body portion 112 formed in a more or less cylindrical shape. The tubular body portion 112 is closed at one end 116. The other end of the tubular body portion 112 has an open mouth 118 for inserting the food product. The open mouth 118 preferably has a diameter substantially equal to that of the body portion forming a rim 119 defining a peripheral sealing surface to which flexible film 117 may be sealed. In addition, the open mouth 118 may also have a lip 124, such as that show in FIG. 6, formed around the rim 119 to better accommodate the sealing film. As noted, the sealing film 117, as shown in FIG. 6, may be heat sealed to the rim/lip using a conventional heat-sealing element 130. The containers of this embodiment may also have indicia 122 affixed thereto to provide pertinent information regarding the product inside the container. As shown in FIG. 4, the containers of this embodiment take up less space in a display case than present meat packages. Also, the container may be stacked in rows.

FIG. 7 illustrates yet another embodiment of the present invention showing a series of containers 210 containing meat for display in a grocery. The container 210 of this embodiment has a tubular body portion 212 formed in a more or less rectangular cross-section. The tubular body portion 212 is closed at one end 216. The other end of the tubular body portion 212 has an open mouth 218 for inserting the food product. The open mouth 218 preferably has a shape and size substantially equal to that of the body portion forming a rim 219 defining a peripheral sealing surface to which a flexible film 217 may be sealed and/or an endcap may be used to seal the open mouth. The container 210 may have indicia 222 printed on or adhered to the walls of the tubular body portion 212 or to the endcap.

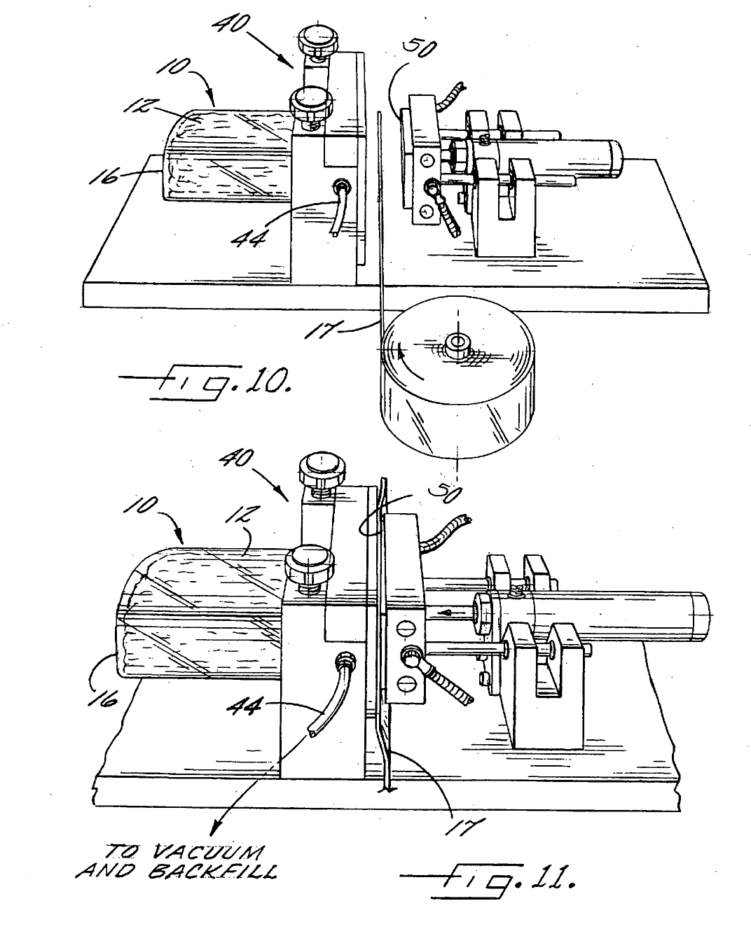

The steps shown in FIGS. 8-11 illustrate the packaging of ground beef into a container of this invention. In FIG. 8 there is shown a container 10 with an open mouth 18 positioned at the end of meat delivery chute 30. A portion of meat 32 ready to be inserted into the container 10 is shown in the chute 30 ahead of plunger 34. The meat 32 is inserted into the container 10 as shown in FIG. 9 by sliding the product into the container 10 using plunger 34. The container is normally filled to about 50% to 75% of capacity with meat.

As noted, the tubular body portion 12 is provided with a gas impermeable seal, film 17. FIG. 10 illustrates the step of sealing the open mouth 18 wherein the filled container 10 is placed in sealer 40, shown in its open position. A roll of film is provided and a section of film 17 is placed across the open mouth 18. The heater head 50 is cycled to the closed position, shown in FIG. 11, to seal the opening. When packaging meat, particularly fresh red meat, once the meat is inserted in the container, the atmosphere in the container may be manipulated to achieve desired storage and display conditions. An atmosphere exchange hose 44 is provided such that the inert atmosphere in the container is removed and an oxygen-rich gas is supplied to the container. The oxygen-rich gas functions to replace the inert gas atmosphere within the container to produce the desired oxygen bloom on the surface of a fresh meat product. As shown in FIG. 11, the exchange hose 44 draws a vacuum to remove the air from the container and then backfills with the oxygen-rich gas. It should be understood that introducing the oxygen-rich gas through the open mouth, before sealing, under pressure will introduce a sufficient amount of oxygen into the container to induce the oxygen bloom in the meat. The pressurized stream of oxygen-rich gas occupies less than the entire area of the open mouth 18, enabling the air to escape the container while the oxygen rich gas is introduced through the open mouth. The thus, treated package achieves the desired storage and display conditions.

Another method of packaging meat is to load the container with product and place it in a vacuum chamber. The chamber is first evacuated, and then is flushed with the desired atmosphere, usually a mixture of 80% oxygen and 20% CO₂ for a high oxygen package. A small amount of carbon monoxide (CO), e.g. less than 5%, such as less than 1%, may also be included with the gas mixture inside the package. The flush can also be a mixture of CO₂ and nitrogen to provide a low oxygen package. The high oxygen package will keep the meat red for a period of around 12-14 days, and will be displayed as it is produced. The low oxygen package will remain in a “bloomable” (i.e. non-red) state for a period of up to 28 days, if kept refrigerated. Any time up to 28 days, the package can be exposed to atmospheric oxygen and the meat will return to a fresh red color. The venting can be achieved by opening a venting device in the closure, for instance. For a high oxygen package, an alternative method to the use of the chamber is just to have a flush hose configured in such a way that the desired mixture of gases, is flushed into the container holding the meat, and in so doing this removes the standard atmosphere from the package replacing it with the desired gas concentration. In all cases, after the atmosphere is modified, a final closure is placed on the package.

### EXAMPLES

### Example 1

A blow molded container was made from PET. This container was trimmed to form a container of approximately rectangular cross section, with final dimensions of approximately 2.25×4.5×6 inches, the open end being approximately 2.25×4.5 inches. The aspect ratio of the container was thus 6/2.25=2.67. A section of this container was cut out, and measured per ASTM spec D 1003-97 using a Gardner Haze Guard Plus instrument, and the sample had a haze level of 3.1%. Product placed inside this sample was very visible.

Calculated permeation rates through the blow molded container described above were preformed to estimate the total permeation of oxygen into the container. Published permeation rates for oxygen through PET are 5 cc mil per 100 square inches of area. Thus, for a container having a thickness of 15 mils, the permeation rate of oxygen would then be 0.3 cc/100 square inches, or approximately 4.65 cc per square meter. The net result would be an approximate permeation rate of 0.27 cc oxygen per day entering a container that initially has no oxygen inside. This is well within the requirements of a typical case ready meat package.

### Example 2

Containers as described in Example 1 are loaded with 1 pound of ground beef and stacked on a shelf in a standard 10 foot retail display case; the shelf holds 160 packages.

### Comparative Example 2

Conventional trays are loaded with 1 pound of ground beef, lidded, and stacked on a shelf in a standard 10 foot retail display case. Even though the internal volume of the resultant packages is the same as the packages in Example 2, because of the flange on the tray, the shelf only holds 52 packages.

### Example 3

Fresh red meat in the form of ground beef was placed in a container as described in Example 1, and the open end was sealed with a PET lidding film. After the container was placed in a refrigerator maintained at 40° F., the inside of the container developed drops of condensation, which obscured the view of the meat product.

### Example 4

Example 3 was repeated, except that the inside of the container was first coated with a 5% solution of a surfactant, Cirrasol PP842, and then allowed to dry. After being loaded with ground beef, sealed, and placed in a refrigerator maintained at 40° F., drops of condensation did not develop. Instead, a thin film of liquid was observed to coat the surface, which did not obscure the view of the meat product.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A container for packaging perishable food items comprising:
a tubular body portion having two ends, said tubular body portion having a cross-section suitable for holding a perishable food item, wherein at least a portion of said tubular body is substantially transparent;
one end of said body portion being closed and the other end of said body portion having an open mouth; and
said open mouth is adapted to be sealed.

2. The container according to claim 1 wherein the cross-section of said tubular body portion is shaped to have a flat bottom.

3. The container according to claim 2 wherein said flat bottom has an undulating profile at each side forming a trough-like area.

4. The container according to claim 1 wherein the cross-section of said body portion is cylindrical.

5. The container according to claim 1 wherein the cross-section of said body portion is generally rectangular.

6. The container according to claim 1 wherein said seal is a heat sealable film.

7. The container according to claim 1 wherein said seal is an endcap.

8. The container according to claim 7 wherein said endcap is attached to the body of the container by friction-fit or a tack-weld.

9. The container according to claim 7 wherein said endcap is attached to the body of the container by screw threads

10. The container according to claim 1 wherein indicia is affixed to said container.

11. The container according to claim 1 wherein said at least a portion of said tubular body is opaque.

12. The container according to claim 1 further comprising a lip projecting radially from the periphery of said mouth opening.

13. The container according to claim 1 wherein the interior of said tubular body portion is coated with an anti-fogging agent.

14. The container according to claim 1 wherein the atmosphere of said container is manipulated to optimize storing conditions.

15. A process for packaging perishable food items comprising:
a. providing a container comprising a tubular body portion having two ends; one end of said body portion being closed and the other end of said body portion having an open mouth; and said open mouth is adapted to be sealed;
b. positioning said container for loading said perishable food item;
c. placing said perishable food item into said container;
d. modifying the atmosphere inside said container to maximize storage conditions, and
e. sealing said container.

16. The process according to claim 15 wherein said perishable food item is loaded into said container with a chute and plunger.

17. The process according to claim 15 wherein said atmosphere is modified in a vacuum chamber.

18. The process according to claim 15 wherein said atmosphere is selected from oxygen, carbon dioxide, nitrogen, carbon monoxide, and blends of the foregoing gases.

19. The process according to claim 15 wherein said perishable food item is fresh red meat.
